(19) United States
(12) Patent Application Publication
(10) Pub. No.: US 2006/0012742 A1
(43) Pub. Date: Jan. 19, 2006

(54) Driving device for active matrix organic light emitting diode display and manufacturing method thereof

(76) Inventors: Yaw-Ming Tsai, Taichung (TW); Shih-Chang Chang, Hsinchu (TW)

Correspondence Address: BIRCH STEWART KOLASCH & BIRCH, PO BOX 747, FALLS CHURCH, VA, 22040-0747, US

(21) Appl. No.: 10/892,176

(22) Filed: Jul. 16, 2004

(51) Int. Cl. G02F 1/1343

(52) U.S. Cl. 349/139

(57) ABSTRACT

A driving device for an active matrix OLED display is disclosed, wherein a pixel electrode is directly contact the substrate, and the pixel electrode is connected electrically to the drain of the thin-film transistor through a drain electrode. Such a device decreases a leakage current and increases emission efficiency. A method of manufacturing the driving device is also disclosed.

### BACKGROUND OF THE PRESENT INVENTION

1. Field of Invention

The invention relates to an active matrix organic light emitting diode display and the manufacturing method of the same. In particular, it relates to a driving device for an organic light emitting diode display and manufacturing method of the same.

2. Related Art

As the technology of thin-film transistor liquid crystal display (TFT LCD) improves, flat screen displays become the mainstream products on the display market. The development of liquid crystal display industry increases the quality and yield of the displays, and also accelerates expectations and demands for the next generation displays. The organic light emitting diode (OLED) display has the features of light, thin, low driving voltage, self-emissive and wide viewing angles. The manufacturing process for the OLED display is also simpler than the LCD displays and the OLED easily applies to flexible displays. It is the next generation display of possibilities.

The driving method of the OLED display includes two types: passive and active matrix type. The passive matrix displays are used mostly in car audio displays, cellular phones, gaming consoles and PDA's. The current commercial products of the OLED display are passive matrix. The advantage of the passive matrix OLED display is no need for color filters and backlight modules due to its simple structure. The disadvantage of the passive matrix OLED is the size limitation. To develop the large size passive matrix displays has some problems such as higher energy consumption, shorter lifetime and deterioration of the OLED device. Active matrix displays provide wider viewing angles, high luminance and quick response time. They conform to the requirements of the large size and high-resolution display. Refer to FIG. 1, illustrating a schematic view of the thin-film transistor according to the related art. A common structure of driving device for active matrix displays includes a driving element (e.g. thin-film transistor) above a substrate 100. An insulating layer 112 above the thin-film transistor covers a source and a drain of the thin-film transistor defined in the poly-Si layer 111 and the gate 14 is located on the insulating layer 112. A dielectric layer 116 lays on the insulating layer 112 and electrodes 115, 117 pass through the layers for connecting to the drain and the source. A planarization layer 130 covers the dielectric layer 116 and the electrodes 1 15, 117. A transparent conductive layer 120 installed on the planarization layer 130 connects to the electrode 1 15 through the planarization layer 130. An organic light emitting diode (not shown) is formed on the top of the transparent conductive layer 120). Active matrix displays formed by the structure described above have low emissive efficiency and larger leakage current than passive matrix displays.

Due to the requirements for the large size and high-resolution displays, the driving device of OLED has to progress from ‘passive matrix’ to ‘active matrix’. Therefore, changing the driving device structure of the active matrix OLED display for improving the emissive efficiency and reducing leakage current has become an important subject for the next generation displays.

### SUMMARY OF THE PRESENT INVENTION

In view of the foregoing, the present invention provides a new driving device for an active matrix OLED display and its manufacturing method. The new structure of the driving device is implemented by forming the pixel electrode directly on a substrate surface by means of a simple production procedure.

The driving device comprises a substrate, a dielectric layer, a thin-film transistor, and a transparent conductive layer. The dielectric layer is formed above the substrate and covers the source and the drain of the thin-film transistor. Source and drain electrode pass through the dielectric layer for separately connecting with the source and drain area. The transparent conductive layer gets direct contact with the substrate and is connected to the drain through the drain electrode, so the transparent conductive layer can be functioned as a pixel electrode. The driving device provides the less leakage current and higher emissive efficiency than the prior active matrix displays.

The present invention also provides a method of manufacturing the driving device for the active matrix OLED display which can simplify process. The method of manufacturing the driving device includes the steps of: providing a substrate; forming a thin-film transistor above the substrate; providing a dielectric layer to cover the source and the drain of the thin-film transistor; forming a contact area that exposes the substrate and holes connecting the source and the drain by executing a photolithography process; filling holes with a conductive layer and form the source electrode and the drain electrode; and forming a transparent conductive layer that directly contact with the substrate through the contact area and is connected to the drain through the drain electrode. Because of the characteristics of the structure, the present invention provides easier manufacturing steps than the prior art of active matrix displays. The present invention uses photolithography process to form separately the contact area, the source and the drain connection holes in the driving device by several steps or one step. Thus, it decreases the amount of masks and the steps of the photolithography process. The present invention can be complete by the current production equipments and there is no need to acquire new equipment.

### BRIEF DESCRIPTION OF THE DRAWINGS

The present invention will become more fully understood from the detailed description given hereinafter that for illustration only, and thus are not limited thereby, and wherein:

FIG. 1, illustrates a schematic view of the thin-film transistor according to related art;

FIG. 2 is a schematic view of a first embodiment of the present invention;

FIG. 3A to 3H are schematic views illustrating a manufacturing process according to the first embodiment of the present invention; and

FIG. 4 is a schematic view of the second embodiment of the present invention.

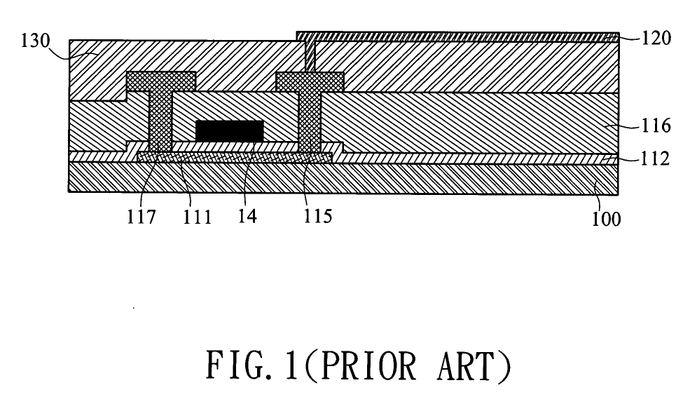

### DETAILED DESCRIPTION OF THE PRESENT INVENTION

The present invention provides a driving device and its manufacturing method for an active matrix OLED display, wherein a the pixel electrode is directly formed on the surface of a substrate so as to reduce leakage current and to increase emissive efficiency.

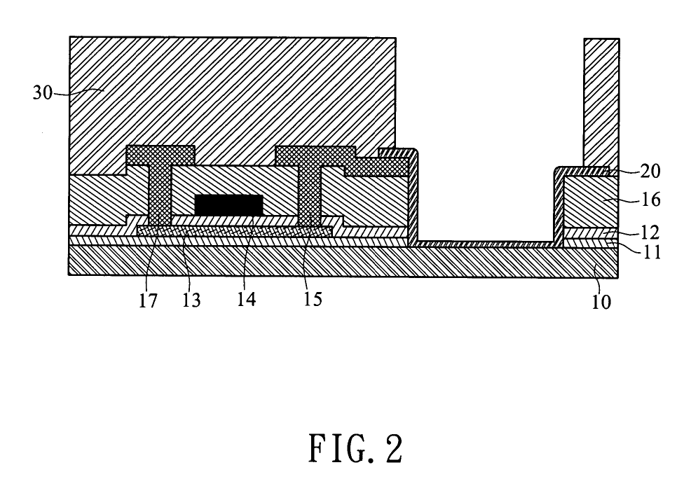

Referring to FIG. 2, a schematic view of a first embodiment according to the present invention is illustrated. An insulated substrate is made up of a substrate 10 and a buffering layer 11. A poly-Si layer 13 is deposited on the surface of the buffering layer 11. A drain, a source, and a channel of a thin-film transistor are defined in the poly-Si layer 13. An insulating layer 12 covers the buffering layer 11 and the poly-Si layer 13. A gate 14 is isolated by the insulating layer 12 and located on the top of the channel in the thin-film transistor. A dielectric layer 16 covers the surface of the gate 14. The dielectric layer 16 and the insulating layer 12 are each provided with connection holes going through to the source and the drain. The connection holes are filled with conductive materials and form the source electrode 17 and the drain electrode 15. A transparent conductive layer 20 contacts the substrate 10 directly, and is connected to the drain through the drain electrode 15. A planarization layer 30 covers the dielectric layer 16 and the source and the drain electrode 15.

The OLED element can be formed on the top surface of the transparent conductive layer 20. An indium tin oxide layer can be used as the transparent conductive layer 20. In addition, a pixel electrode made up of the transparent conductive layer contacts with the substrate directly, the planarization layer lays over the edges of the transparent conductive layer to reduce the roughness of the transparent conductive layer. The leakage current between the pixel electrode and the other electrodes is thus reduced.

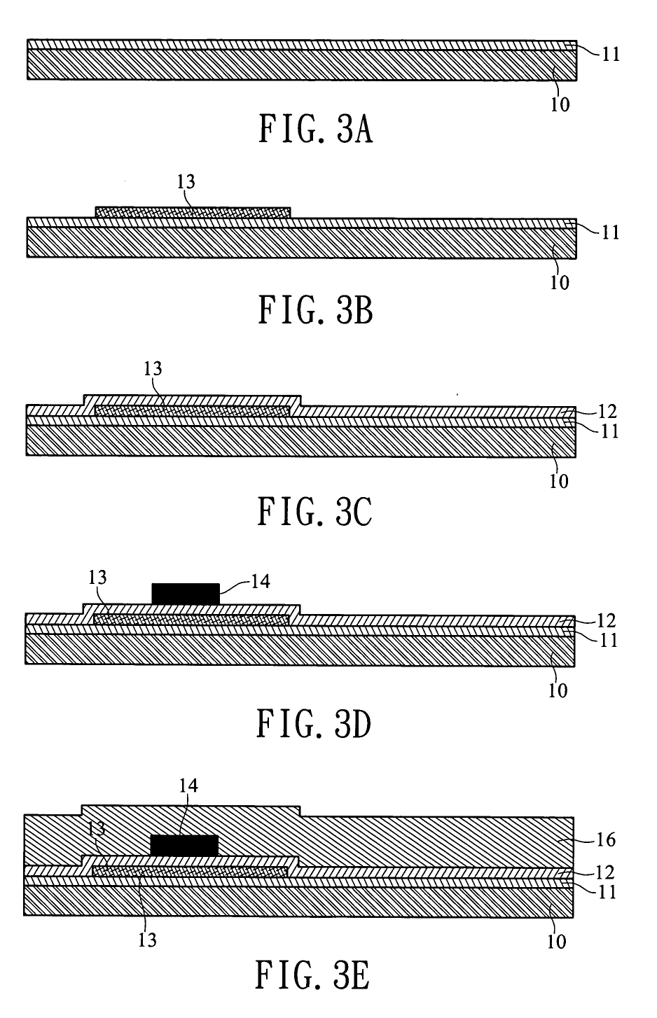

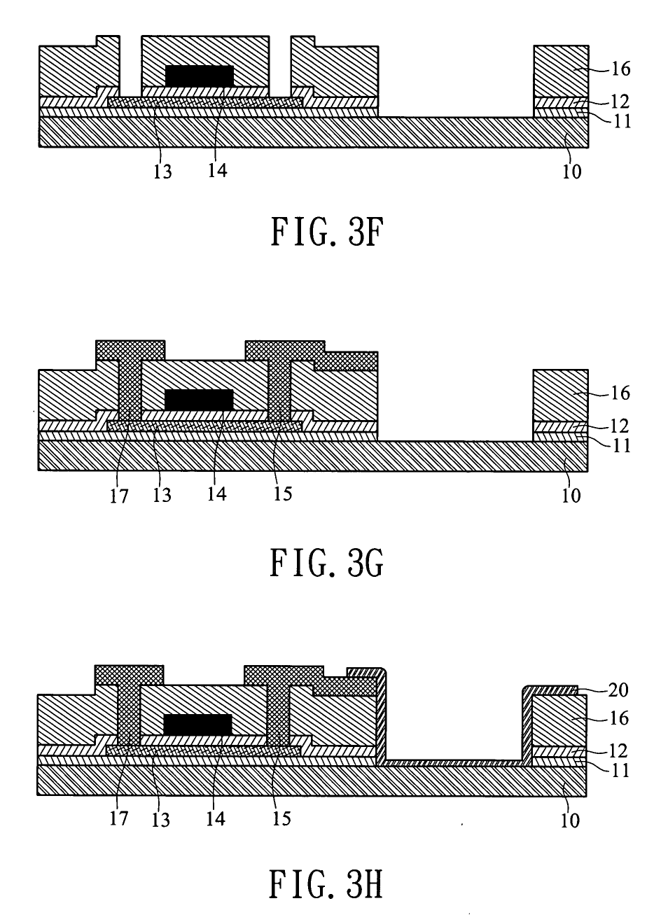

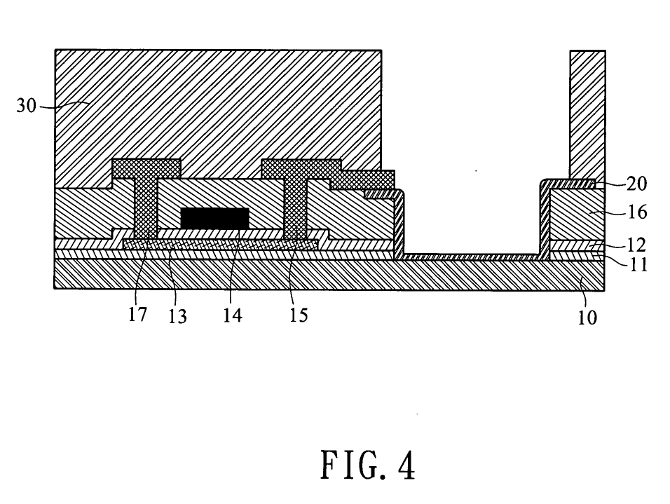

FIG. 3A to 4H are schematic views illustrating a process according to the first embodiment of the present invention. First of all, the substrate 10 that is covered by the buffering layer 11 on its surface (FIG. 3A) is provided and from the poly-Si layer 13 is formed on the top of the buffering layer 11 (FIG. 3B), which has the source, the drain, and the channel the insulating layer 12 is formed to cover the source and the drain of the thin-film transistor (FIG. 3C) and then the gate 14 (FIG. 3D) is formed, which is isolated by the insulating layer 12 and located on the top of the channel area of the thin-film transistor. Then, the dielectric layer 16 is formed to cover the gate 14 (FIG. 3E), a contact area that exposes the substrate 10 and the connection holes for the source and the drain is formed by executing a photolithography process (FIG. 3F). The connection holes is filled with metal (FIG. 3G) to form the source electrode 17 and the drain electrode 15. The transparent conductive layer 20 is formed directly contact with the substrate 10 through the contact area (FIG. 3H) and is connected to the drain through the drain electrode 15. Finally, cover a planarization layer 30 is formed to lay over the dielectric layer 16 and the source and the drain electrode 15 (FIG. 2).

The transparent conductive layer can be provided either above or below the extended part of the drain electrode, referring to FIG. 4, a schematic view of a second embodiment according to the present invention is illustrated. The transparent conductive layer is provided below an extended part of the drain electrode.

The present invention is thus described. However, it will be obvious that this invention may be varied in many ways. Such variations are not to be regarded as a departure from the spirit and scope of the present invention, and all such modifications would be obvious to one skilled in the art and are intended to be included within the scope of the following claims.

What is claimed is:

1. A driving device for an active matrix organic light emitting diode display, including a substrate, a thin-film transistor with a drain and a source, and a transparent conductive layer which directly contacts the substrate and is electrically connected to the drain through a drain electrode.

2. The driving device of claim 1, wherein the transparent conductive layer is an indium tin oxide layer.

3. The driving device of claim 1, further comprising a dielectric layer that separats the drain from the transparent conductive layer.

4. The driving device of claim 1, further comprising a buffering layer located on the substrate surface to separate the substrate from the thin-film transistor.

5. A driving device for an active matrix organic light emitting diode display, comprising:
a substrate;
a thin-film transistor, which includes a source and a drain, formed on the substrate;
a dielectric layer formed above the substrate to cover the source and the drain of the thin-film transistor; and
a transparent conductive layer, which contacts the surface of the substrate directly and is connected to the drain through the drain electrode.

6. The driving device of claim 5, wherein the substrate is a glass substrate.

7. The driving device of claim 5, wherein the transparent conductive layer is an indium tin oxide layer.

8. The driving device of claim 5, further comprising a buffering layer that is separated the substrate from the thin-film transistor.

9. The driving device of claim 5, wherein the thin-film transistor is a poly-Si thin-film transistor.

10. A manufacturing method of a driving device for an active matrix organic light emitting diode display, comprising the steps of:
providing a substrate;
forming a thin-film transistor above the substrate, which includes a source and a drain;
providing a dielectric layer to cover the source and the drain of the thin-film transistor;
forming a contact area that exposes the substrate is exposed, a connection hole for the source, and a connection hole for the drain by executing a photolithography process;
filling the connection holes with conductive layer to form the source electrode and the drain electrode; and
forming a transparent conductive layer that directly contacts the substrate and is electrically connected to the drain through the drain electrode.

11. The manufacturing method of claim 10, wherein the substrate is a glass substrate.

12. The manufacturing method of claim 10, wherein the transparent conductive layer is an indium tin oxide layer.

13. The manufacturing method of claim 10, further comprising the step of forming a buffering layer on the substrate before the step of forming the thin-film transistor above the substrate.

14. The manufacturing method of claim 10, wherein the thin-film transistor is a poly-Si thin-film transistor.
